(19) United States
(12) Patent Application Publication
(10) Pub. No.: US 2024/0210205 A1
(43) Pub. Date: Jun. 27, 2024

(54) COMMUNICATION DEVICE AND VEHICLE

(71) Applicant: Toyota Jidosha Kabushiki Kaisha, Toyota-shi (JP)

(72) Inventor: Makoto MATSUSHITA, Ichinomiya-shi (JP)

(73) Assignee: Toyota Jidosha Kabushiki Kaisha, Toyota-shi (JP)

(21) Appl. No.: 18/469,985

(22) Filed: Sep. 19, 2023

(30) Foreign Application Priority Data
Dec. 21, 2022 (JP) 2022204713

(51) Int. Cl. G01C 21/00

(52) U.S. Cl. CPC G01C 21/3841; G01C 21/3815; G01C 21/3896

(57) ABSTRACT

In a case where the communication device can communicate with the server device and other communication devices mounted on other probe vehicles around the probe vehicle, and N is a real number of zero or more and M is an integer of one or more, the probe data obtained from the probe vehicle is not transmitted when M or more time stamps within the past N minutes corresponding to the link are received from the surroundings of the probe vehicle before the probe vehicle has passed through the link in the road network, and the probe data is transmitted to the server device in association with the link, a time stamp corresponding to the link is generated, and the generated time stamp is transmitted to the surroundings of the probe vehicle when M or more time stamps within the past N minutes corresponding to the link are not received.

### CROSS-REFERENCE TO RELATED APPLICATION

This application claims priority to Japanese Patent Application No. 2022-204713 filed on Dec. 21, 2022, incorporated herein by reference in its entirety.

### BACKGROUND

### 1. Technical Field

The present disclosure relates to a communication device and a vehicle.

### 2. Description of Related Art

Japanese Unexamined Patent Application Publication No. 2019-128697 (JP 2019-128697 A) discloses a method for collecting probe data from a plurality of vehicles.

### SUMMARY

In conventional methods, a central server receives probe data from all of a plurality of vehicles. The server collectively processes the received probe data to generate traffic information. Therefore, the processing amount of the server is enormous. As a result, a lot of processing costs are incurred.

An object of the present disclosure is to reduce the processing amount of the server device.

A communication device according to the present disclosure is a communication device mounted on a probe vehicle, and includes:

a communication unit that is able to communicate with a server device and communicate with another communication device mounted on another probe vehicle around the probe vehicle; and
a control unit that does not transmit probe data obtained from the probe vehicle when N is a real number of zero or more and M is an integer of one or more, and M or more time stamps within past N minutes corresponding to a link within a road network are received from surroundings of the probe vehicle via the communication unit before the probe vehicle finishes passing through the link, and that transmits the probe data to the server device via the communication unit in association with the link, generates a time stamp corresponding to the link, and transmits the generated time stamp to the surroundings of the probe vehicle via the communication unit when the M or more time stamps within the past N minutes corresponding to the link are not received.

According to the present disclosure, it is possible to reduce the processing amount of the server device.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram illustrating a configuration of a navigation system according to an embodiment of the present disclosure;

FIG. 2 is a diagram illustrating an example of a plurality of probe vehicles according to an embodiment of the present disclosure;

FIG. 3 is a block diagram illustrating a configuration of a communication device according to an embodiment of the present disclosure;

FIG. 4 is a diagram illustrating an exemplary operation of a communication device according to an embodiment of the present disclosure; and

FIG. 5 is a diagram illustrating another example of the operation of the communication device according to the embodiment of the present disclosure.

### DETAILED DESCRIPTION OF EMBODIMENTS

Hereinafter, an embodiment of the present disclosure will be described with reference to the drawings.

In each drawing, the same or corresponding portions are denoted by the same reference signs. In the description of the present embodiment, description of the same or corresponding components will be appropriately omitted or simplified.

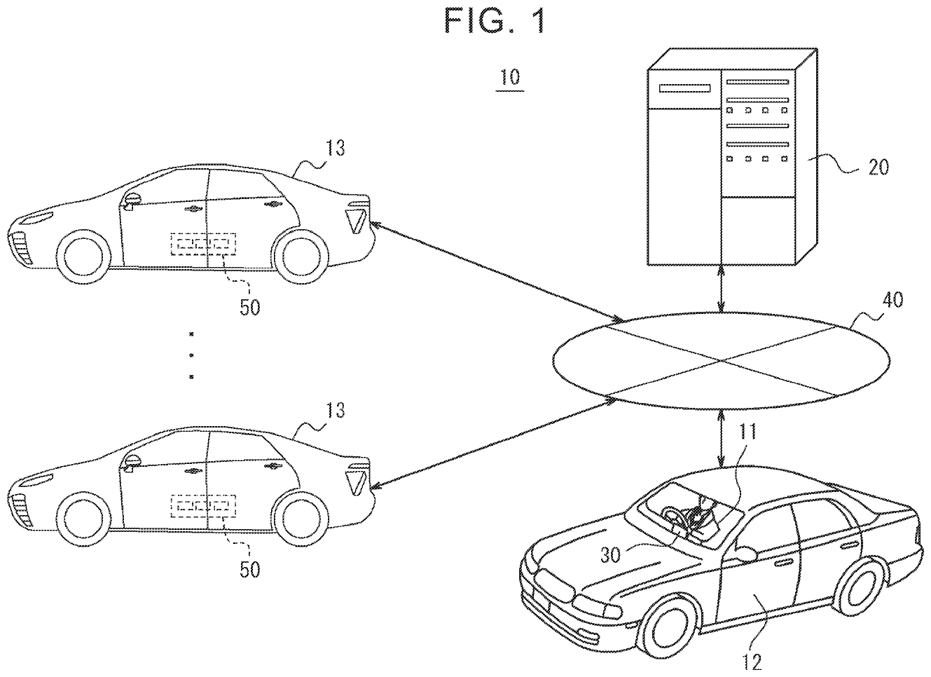

A configuration of the navigation system 10 according to the present embodiment will be described with reference to FIG. 1.

The navigation system 10 includes a server device 20, a navigation device 30, and a plurality of communication devices 50. The server device 20 can communicate with the navigation device 30 and the plurality of communication devices 50 via the network 40.

The server device 20 is installed in a facility such as a data center. The server device 20 is operated by an operator. The server device 20 is a computer belonging to a cloud computing system or other computing system.

The navigation device 30 is mounted on the vehicle 12. The navigation device 30 is used by the user 11. The navigation device 30 is an in-vehicle device having a function of guiding a route to a destination to the user 11, such as a car navigation device. Alternatively, the navigation device 30 may be connected to the vehicle 12 as an external device or may be held by the user 11. The navigation device 30 may be a mobile device having a function of guiding a route to a destination to the user 11, such as a mobile phone, a smartphone, or a tablet in which a map application is installed.

Vehicle 12 may be any type of vehicle, such as, for example, a gas-powered vehicle, a die-powered vehicle, a HEV, PHEV, BEV, or a FCEV. “HEV” is an abbreviation for hybrid electric vehicle. “PHEV” is an abbreviation for plug-in hybrid electric vehicle. “BEV” is an abbreviation for battery electric vehicle. “FCEV” is an abbreviation for fuel cell electric vehicle. The vehicle 12 is driven by the user 11 in the present embodiment, but the driving may be automated at an arbitrary level. The level of autonomous driving is, for example, one of levels 1 to 5 in the SAE leveling, for example. “SAE” is an abbreviation for Society of Automotive Engineers. The vehicle 12 may be a MaaS dedicated vehicle. MaaS is an abbreviation for Mobility as a Service.

Each communication device 50 is mounted on a corresponding probe vehicle 13. Each communication device 50 is capable of communicating with the server device 20 via the network 40. Each communication device 50 is capable of communicating wirelessly with other communication devices 50 mounted on other probe vehicles 13 around the corresponding probe vehicle 13.

Each probed vehicle 13 is any type of vehicle, such as a gasoline vehicle, diesel vehicle, hydrogen vehicle, HEV, PHEV, BEV, or FCEV, for example. Each probe vehicle 13 is driven by a driver in the present embodiment, but the driving may be automated at an arbitrary level. The level of autonomous driving is, for example, one of levels 1 to 5 in the SAE leveling, for example. Each probe vehicle 13 may be a MaaS dedicated vehicle.

The network 40 includes the Internet, at least one WAN, at least one MAN, or any combination thereof. WAN is an abbreviation for wide area network. MAN is an abbreviation for metropolitan area network. The network 40 may include at least one wireless network, at least one optical network, or any combination thereof. The wireless network is, for example, an ad hoc network, a cellular network, a wireless LAN, a satellite communication network, or a terrestrial microwave network. The term “LAN” is an abbreviation for “local area network”.

The outline of the present embodiment will be described with reference to FIG. 1.

Let N be a real number greater than or equal to 0. M is an integer equal to or greater than 1. Each of the communication devices 50 does not transmit probe data obtained from the corresponding probe vehicle 13 when M or more time stamps within the past N minutes corresponding to the link are received from the periphery of the corresponding probe vehicle 13 before the corresponding probe vehicle 13 passes through the link in the road network. Each of the communication devices 50 transmits the probe data to the server device 20 in association with the link, generates a time stamp corresponding to the link, and transmits the generated time stamp to the surroundings of the corresponding probe vehicle 13, when M or more time stamps within the past N minutes corresponding to the link have not been received before the corresponding probe vehicle 13 has passed through the link. Upon receiving the probe data, the server device 20 processes the received probe data to generate traffic information such as traffic jam information. The server device 20 distributes the generated traffic information to the navigation device 30. Upon receiving the traffic information, the navigation device 30 notifies the user 11 of the received traffic information.

If probe data is collected from a certain number of probe vehicles 13 within a certain period of time per link, it is sufficient to generate traffic information. According to the present embodiment, the server device 20 does not need to receive probe data from all of the plurality of probe vehicles 13. For example, the server device 20 can receive only the amount of probe data necessary to generate the traffic information. Therefore, the server device 20 can generate traffic information only by processing a necessary amount of probe data. The server device 20 does not need to select probe data depending on whether it is necessary or unnecessary to generate traffic information. Therefore, the processing amount of the server device 20 can be reduced. As a result, the processing cost can be reduced.

Communication costs can also be reduced.

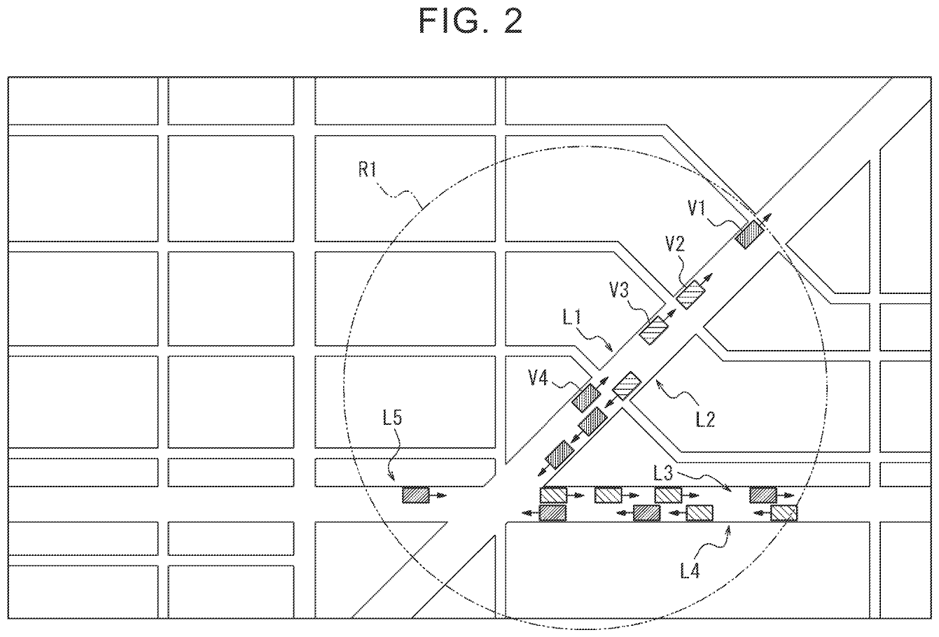

For example, as shown in FIG. 2, it is assumed that four probe vehicles 13 on V4 pass through a L1 which is one link in the road network from V1. For L1, it is assumed that M is set to 1. If the communication device 50 mounted on V1 has not received the time stamp corresponding to L1 within N minutes from the time when V1 finishes passing through L1, the communication device 50 mounted on V1 uploads the probe data corresponding to L1 and broadcasts the time stamp corresponding to L1. This time stamp is received from V2 by the communication device 50 mounted on the probe vehicle 13 located in R1, which is the area encompassing L1, such as V4, in direct or inter-vehicle communication. If N minutes have not elapsed since the communication device 50 mounted on V2 received the time stamp when L1 is over when V2 passes through, the communication device 50 mounted on V2 does not upload the probe data and does not broadcast the time stamp. V3 is also the same as V2. If N minutes have elapsed since the communication device 50 mounted on V4 received the time stamp when L1 passes through V4, the communication device 50 mounted on V4 uploads the probe data corresponding to L1 and broadcasts the time stamp corresponding to L1. Other links in the road network, such as L2 to L5, are similar to L1.

As in this example, in the present embodiment, the probe vehicle 13 in the same link performs arbitration in short-range communication. As a result of the arbitration, only the required number of probe vehicles 13 transmits the probe data to the server device 20. Therefore, the server device 20 can generate traffic information only by processing a necessary amount of probe data. Since the link includes a trip and a trip, the server device 20 can generate, for example, traffic jam information for each traveling direction.

N may be set for each link in the road network according to the switching timing, time zone, or day of the week of the signal. M may be set for each link in the road network according to the road case, the number of lanes, the time zone, or the day of the week.

For example, the probe data includes a link ID identifying the corresponding link, a heading of the corresponding link, a velocity of the probe vehicle 13 of the transmission source, and a transmission time of the probe data. The term “ID” is an abbreviation for identifier. For example, the time stamp includes a link ID identifying the corresponding link, a heading of the corresponding link, and a sending time of the corresponding probe data. Alternatively, the timestamp may be the same content as the corresponding probe data. Congestion when a time stamp is broadcast can be suppressed by general congestion control.

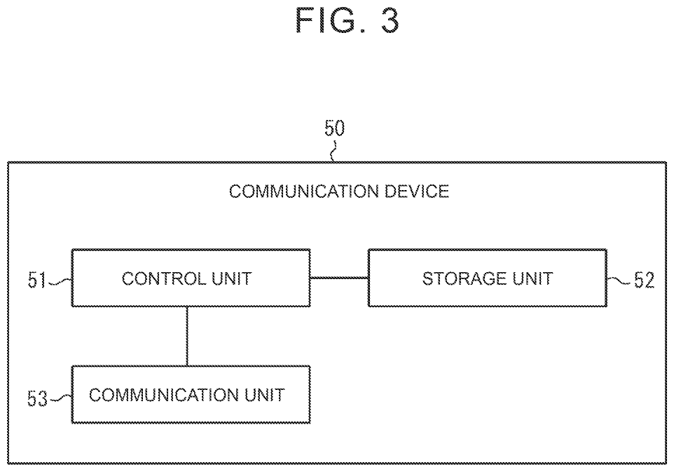

With reference to FIG. 3, the configuration of the communication device 50 mounted on each probe vehicle 13 will be described.

The communication device 50 includes a control unit 51, a storage unit 52, and a communication unit 53.

The control unit 51 includes at least one processor, at least one programmable circuit, at least one dedicated circuit, or any combination thereof. The processor is a general-purpose processor such as a CPU or a GPU, or a dedicated processor specialized for a specific process. The term “CPU” is an abbreviation for “central processing unit”. The term “GPU” is an abbreviation for “graphics processing unit”. The programmable circuit is, for example, an FPGA. The term “FPGA” is an abbreviation for “field-programmable gate array”. The dedicated circuit is, for example, an ASIC. The term “ASIC” is an abbreviation for “application specific integrated circuit”. The control unit 51 executes processing related to the operation of the communication device 50 while controlling each unit of the communication device 50.

The storage unit 52 includes at least one semiconductor memory, at least one magnetic memory, at least one optical memory, or any combination thereof. The semiconductor memory is, for example, a RAM, a ROM, or a flash memory. The term “RAM” is an abbreviation for “random access memory”. The term “ROM” is an abbreviation for “read-only memory”. The RAM is, for example, an SRAM or a DRAM. The term “SRAM” is an abbreviation for “static random access memory”. The term “DRAM” is an abbreviation for “dynamic random access memory”. The ROM is, for example, an EEPROM. The term “EEPROM” is an abbreviation for “electrically erasable programmable read-only memory”. The flash memory is, for example, an SSD. “SSD” is an abbreviation for solid-state drive. The magnetic memory is, for example, an HDD. “HDD” is an abbreviation for hard disk drive. The storage unit 52 functions as, e.g., a main storage device, an auxiliary storage device, or a cache memory. The storage unit 52 stores data used for the operation of the communication device 50 and data obtained by the operation of the communication device 50.

The communication unit 53 includes at least one communication interface. The communication interface is, for example, an interface corresponding to a mobile communication standard such as LTE, 4G standard or 5G standard, a V2X communication standard such as DSRC or the cellular V2X, or a wireless LAN communication standard such as IEEE802.11. The term “LTE” is an abbreviation for “long term evolution”. The term “4G” is an abbreviation for “fourth generation”. The term “5G” is an abbreviation for “fifth generation”. “DSRC” is an abbreviation for dedicated short range communications. The term “V2X” is an abbreviation for “vehicle-to-everything”. “IEEE” is an abbreviation for Institute of Electrical and Electronics Engineers. For example, it is conceivable that an interface corresponding to the mobile communication standard communicates with the server device 20, and an interface corresponding to V2X communication standard communicates with another communication device 50. The communication unit 53 receives data used for the operation of the communication device 50 and transmits data obtained by the operation of the communication device 50.

The function of the communication device 50 is realized by executing the program according to the present embodiment by a processor serving as the control unit 51. That is, the function of the communication device 50 is realized by software. The program causes the computer to function as the communication device 50 by causing the computer to execute the operation of the communication device 50. That is, the computer functions as the communication device 50 by executing the operation of the communication device 50 in accordance with the program.

The program can be stored in a non-transitory computer-readable medium. The non-transitory computer-readable medium is, for example, a flash memory, a magnetic recording device, an optical disc, an opto-magnetic recording medium, or a ROM. The distribution of the program is carried out, for example, by selling, transferring, or renting a portable medium such as an SD card, a DVD, or a CD-ROM in which the program is stored. The term “SD” is an abbreviation for “secure digital”. The term “DVD” is an abbreviation for “digital versatile disc”. The term “CD-ROM” is an abbreviation for “compact disc read-only memory”. The program may be stored in the storage of the server and transferred from the server to other computers to distribute the program. The program may be provided as a program product.

The computer temporarily stores the program stored in the portable medium or the program transferred from the server in the main storage device, for example. The computer then causes the processor to read the program stored in the main storage device, and causes the processor to execute processes in accordance with the read program. The computer may read the program directly from the portable medium and execute processes in accordance with the program. The computer may execute the processes in accordance with the received program each time the program is transferred from the server to the computer. The processes may be executed by a so-called ASP service that realizes the function only by execution instruction and result acquisition without transferring the program from the server to the computer. The term “ASP” is an abbreviation for “application service provider”. The program includes information that is used for processing by electronic computers and equivalent to a program. For example, data that is not a direct command to a computer but has the property of defining the processing of the computer corresponds to the “data equivalent to a program”.

Some or all of the functions of the communication device 50 may be realized by a programmable circuit or a dedicated circuit as the control unit 51. That is, some or all of the functions of the communication device 50 may be realized by hardware.

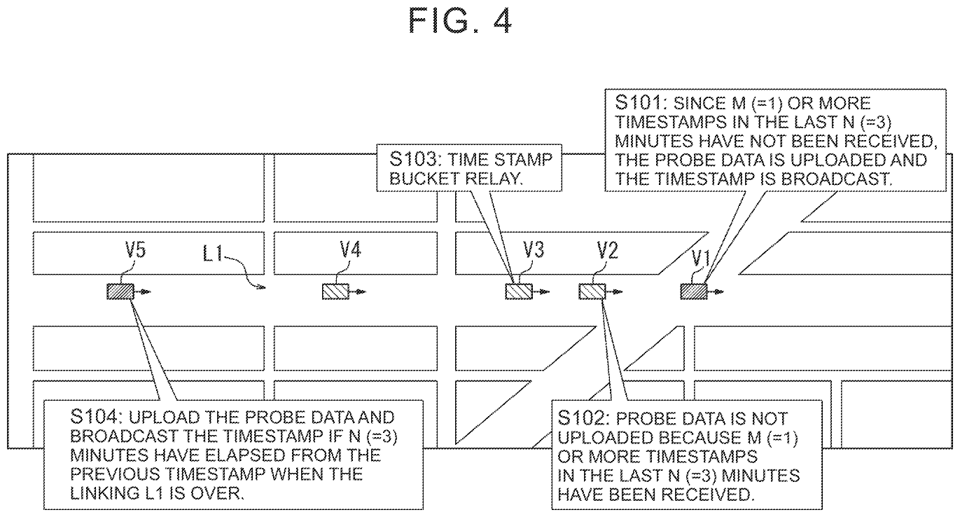

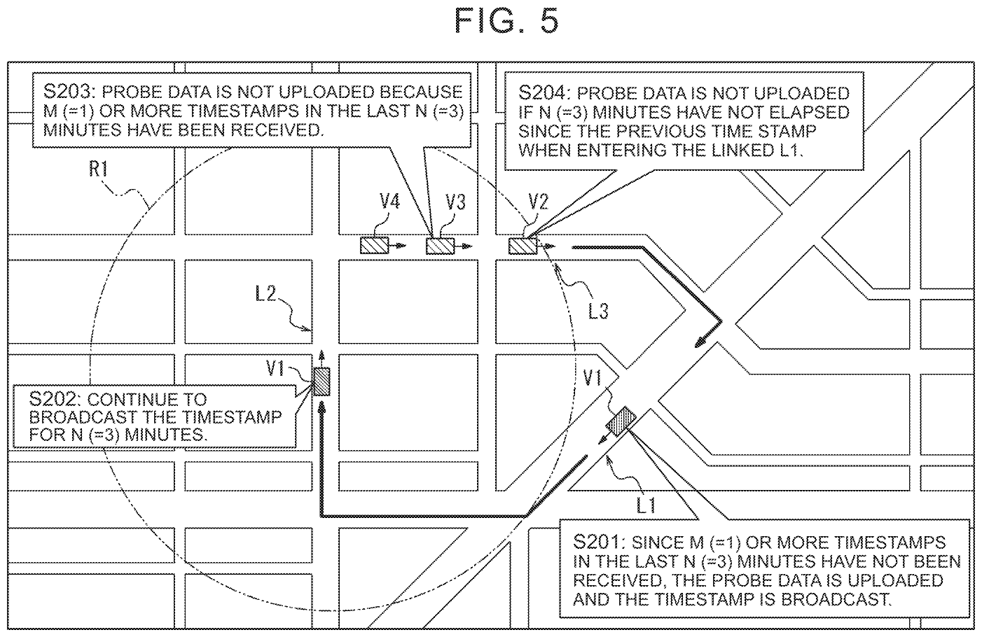

With reference to FIGS. 4 and 5, the operation of the communication device 50 mounted on each probe vehicle 13 will be described. The operation of the communication device 50 corresponds to the communication method according to the present embodiment.

In the embodiment shown in FIG. 4, five probe vehicles 13 from V1 to V5 pass through an L1 that is one-link in the road network. For L1, N is set to 3 and M is set to 1.

In S101, it is assumed that the control unit 51 of the communication device 50 mounted on V1 does not receive the time stamp corresponding to L1 within N minutes from the time when V1 finishes passing through L1. The control unit 51 of the communication device 50 mounted on V1 transmits the probe data obtained from V1 to the server device 20 via the communication unit 53 of the communication device 50 mounted on V1 in association with L1 since M or more time stamps within the past N minutes corresponding to L1 have not been received until V1 finishes passing through L1. The control unit 51 of the communication device 50 mounted on V1 generates a time stamp corresponding to L1. The control unit 51 of the communication device 50 mounted on V1 transmits the generated time stamp to the surroundings of V1 via the communication unit 53 of the communication device 50 mounted on V1.

In S102, it is assumed that the control unit 51 of the communication device 50 mounted on V2 receives, from the communication device 50 mounted on L2 via the communication unit 53 of the communication device 50 mounted on V2, the time stamp transmitted by S101 within N minutes retroactively from the time when V2 has passed through V1. The control unit 51 of the communication device 50 mounted on V2 does not transmit the probe data obtained from V2 because M or more time stamps corresponding to L1 for N minutes or less have been received before V2 passes through L2. The control unit 51 of the communication device 50 mounted on V2 transfers the received time stamp to the communication device 50 mounted on V3 via the communication unit 53 of the communication device 50 mounted on V2.

In S103, it is assumed that the control unit 51 of the communication device 50 mounted on V3 receives, from the communication device 50 mounted on L2 via the communication unit 53 of the communication device 50 mounted on V3, the time stamp transferred by S102 within N minutes retroactively from the time when V3 finishes passing through V2. The control unit 51 of the communication device 50 mounted on V3 does not transmit the probe data obtained from V3 because M or more time stamps corresponding to L1 for N minutes or less have been received before V3 passes through L2. The control unit 51 of the communication device 50 mounted on V3 transfers the received time stamp to the communication device 50 mounted on V4 via the communication unit 53 of the communication device 50 mounted on V3. Similarly, it is assumed that the control unit 51 of the communication device 50 mounted on V4 receives the transferred time stamp from the communication device 50 mounted on V3 via the communication unit 53 of the communication device 50 mounted on V4 within N minutes from the time when V4 finishes passing through L2. The control unit 51 of the communication device 50 mounted on V4 does not transmit the probe data obtained from V4 because M or more time stamps corresponding to L1 for N minutes or less have been received before V4 passes through L2. The control unit 51 of the communication device 50 mounted on V4 transfers the received time stamp to the communication device 50 mounted on V5 via the communication unit 53 of the communication device 50 mounted on V4.

In S104, it is assumed that the control unit 51 of the communication device 50 mounted on V5 receives, via the communication unit 53 of the communication device 50 mounted on V5, the time stamp transferred by S103 from the communication device 50 mounted on V4 prior to N minutes from the time when V5 passes through L2. The control unit 51 of the communication device 50 mounted on V5 transmits the probe data obtained from V5 to the server device 20 via the communication unit 53 of the communication device 50 mounted on V5 in association with L1 since M or more time stamps corresponding to L1 for N minutes or less have not been received before V5 has passed through L2. The control unit 51 of the communication device 50 mounted on V5 generates a time stamp corresponding to L1. The control unit 51 of the communication device 50 mounted on V5 transmits the generated time stamp to the surroundings of V5 via the communication unit 53 of the communication device 50 mounted on V5.

In the embodiment shown in FIG. 5, three probe vehicles 13 from V2 to V4 pass through an L3 that is one-link in the road network. After V1, which is another probe vehicle 13, passes through L3 and L1, it passes through L2, which is another link in the road network. For L3, N is set to 3 and M is set to 1.

In S201, it is assumed that the control unit 51 of the communication device 50 mounted on V1 does not receive the time stamp corresponding to L3 within N minutes from the time when V1 finishes passing through L3. The control unit 51 of the communication device 50 mounted on V1 transmits the probe data obtained from V1 to the server device 20 via the communication unit 53 of the communication device 50 mounted on V1 in association with L3 since M or more time stamps within the past N minutes corresponding to L3 have not been received until V1 has passed through L3. The control unit 51 of the communication device 50 mounted on V1 generates a time stamp corresponding to L3. The control unit 51 of the communication device 50 mounted on V1 transmits the generated time stamp to the surroundings of V1 via the communication unit 53 of the communication device 50 mounted on V1.

In S202, the control unit 51 of the communication device 50 mounted on V1 continues to transmit the time stamp generated by S201 to the periphery of V1 via the communication unit 53 of the communication device 50 mounted on V1 for N minutes.

For example, S201 process is performed when V1 finishes passing through L3 and enters L1. S202 process is continued when V1 passes through L1 and then passes through L2. When V1 is passing through L1, it is assumed that V2 and V4 are not located within R1 that is V1 short-range communication area. Thereafter, as shown in FIG. 5, when V1 is passing through L2, it is assumed that V4 is located in R1 from V2.

In S203, it is assumed that the control unit 51 of the communication device 50 mounted on V4 receives, from the communication device 50 mounted on V1 via the communication unit 53 of the communication device 50 mounted on V4, the time stamp transmitted when V1 passes through L2 in S202 within N minutes from the time when V4 finishes passing through L2. The control unit 51 of the communication device 50 mounted on V4 does not transmit the probe data obtained from L2 because M or more time stamps corresponding to L1 for N minutes or less have been received before V4 passes through the communication device. V3 mounted communication device 50 is also the same as V4 mounted communication device 50.

In S204, it is assumed that the control unit 51 of the communication device 50 mounted on V2 receives, from the communication device 50 mounted on V1 via the communication unit 53 of the communication device 50 mounted on V2, the time stamp transmitted when V1 passes through L2 in S202 within N minutes from the time when V2 finishes passing through L2. The control unit 51 of the communication device 50 mounted on V2 does not transmit the probe data obtained from L2 because M or more time stamps corresponding to L1 for N minutes or less have been received before V2 passes through the communication device.

As described above, in the present embodiment, the probe vehicle 13 that has generated the probe data broadcasts a time stamp to the surroundings by short-range communication for a certain period of time as information indicating when the data corresponding to which link is uploaded. Therefore, even if the other probe vehicle 13 is not located within the short-range communication range at the start of broadcast, there is a possibility that the time stamp may be delivered to the other probe vehicle 13 until a certain period of time has elapsed and unnecessary probe data may be prevented from being transmitted from the other probe vehicle 13 to the server device 20.

The present disclosure is not limited to the embodiment described above. For example, two or more blocks shown in the block diagram may be integrated, or a single block may be divided. Instead of executing two or more steps shown in the flowchart in chronological order according to the description, the steps may be executed in parallel or in a different order, depending on the processing capacities of the devices that execute the steps, or as necessary. Other changes may be made without departing from the scope of the present disclosure.

What is claimed is:

1. A communication device mounted on a probe vehicle, the communication device comprising:
a communication unit that is able to communicate with a server device and communicate with another communication device mounted on another probe vehicle around the probe vehicle; and
a control unit that does not transmit probe data obtained from the probe vehicle when N is a real number of zero or more and M is an integer of one or more, and M or more time stamps within past N minutes corresponding to a link within a road network are received from surroundings of the probe vehicle via the communication unit before the probe vehicle finishes passing through the link, and that transmits the probe data to the server device via the communication unit in association with the link, generates a time stamp corresponding to the link, and transmits the generated time stamp to the surroundings of the probe vehicle via the communication unit when the M or more time stamps within the past N minutes corresponding to the link are not received.

2. The communication device according to claim 1, wherein the control unit continues to transmit the generated time stamp for N minutes.

3. The communication device according to claim 1, wherein N is set for each link within the road network according to a signal switching timing, a time zone, or a day.

4. The communication device according to claim 1, wherein M is set for each link within the road network according to a road rank, the number of lanes, a time zone, or a day.

5. A vehicle, wherein the vehicle includes the communication device according to claim 1, and functions as the probe vehicle.
